(19) United States
(12) Patent Application Publication
(10) Pub. No.: US 2023/0415928 A1
(43) Pub. Date: Dec. 28, 2023

(54) Warning Spheres Installation using Drones

(71) Applicants: Alon Wallach, Ramat Gan (IL); Michael Etgar Eisenstadt, Kefar Saba (IL)

(72) Inventors: Alon Wallach, Ramat Gan (IL); Michael Etgar Eisenstadt, Kefar Saba (IL)

(21) Appl. No.: 18/221,399

(22) Filed: Jul. 13, 2023

Related U.S. Application Data
(60) Provisional application No. 63/474,075, filed on Jul. 19, 2022.

(51) Int. Cl. B64U 10/16; B64D 1/22; G05D 1/00; H02G 1/02

(52) U.S. Cl. CPC B64U 10/16; B64D 1/22; G05D 1/0038; H02G 1/02; B64U 2201/20; B64U 2101/30

(57) ABSTRACT

A method and system for installing warning spheres on utility power lines using existing commercial drones and an unique preassembled warning sphere with an inverted U shape opening in its lower half, one or more cable clamp in the upper part of the inverted U which matches the utility cable's diameter, number of strands and longitudinal spiral pitch. The warning sphere also has two receptacles in its circumference for catching the drones retractable landing gears fitted with matching bulges, enabling the safe lifting and flying of the sphere, The Drone also has a 3D stereoscopic camera which is integrated to its video system, thus enabling the precise navigating of the drone directly above the utility cable, and then directing the drone and sphere's U slot and cable clamp into the cable, either manually, or automatically through modulating of the sticks command of the remote control of the drone.

### FIELD OF INVENTION

The present invention is in the field of utility infrastructure, and in particular in transmission power lines, where warning spheres must be installed to aid low flying pilots and prevent accidents of planes and helicopters hitting high voltage power lines. Currently as of year 2022, all warning spheres in the world are installed by manned helicopters under extreme life risking conditions or preassembled on the ground into newly installed power lines. These warning spheres are mandatory through the FAA advisory circular AC No: 70/7460-1L from 2015, and is accepted and implemented by most countries since the 1950s.

### DESCRIPTION OF RELATED ART

Except for a single patent from 2014 by McNally number U.S. Pat. No. 9,932,110B2 suggesting warning spheres installation with a drone, there are no other relevant patents nor recorded success, not even on a trial or pilot phase, of such installation by a drone, although drones are around us for about 15 years. McNally filed his patent after flying such manned helicopter, and his ideas and concepts described in his patent have not been implemented or augmented by any more patents or publications, not his and not others'. There could be commercial reasons for this concept to remain on the drawing board, but there are also obvious technical deficiencies in the McNally patent that make it immature. In particular, in addition to generally being a cumbersome solution in the way the sphere is attached and detached from the drone, and the way rotational power is transferred from the drone into the sphere's attaching mechanism to the cable, his patent doesn't answer the crucial practical question of how exactly to approach the electric cable without hitting it or another cable nearby, how the remote operator of the drone can assess the exact height of the drone from the cable, how to accurately align the sphere U opening into the cable, and then what happens during the many seconds when the drone plus sphere are touching and even leaning on the cable. He tried to circumvent those problems by mentioning a vague “flight control system” and a variety of sensors in claim 13, sensors carried by the drone, but it is apparent from his general description that he didn't really know how to tackle it.

Also, although his patent lists in claims 14-15 many securing options of how the sphere is attached to the cable, none of them prevents the sphere from rotating or sliding along the cable, a requirement of the electric companies, to prevent sphere gravitational sliding, or accumulated abrasive damage created by the sphere's attaching mechanism and screws etc. to the aluminum strands of the cable from thousands of left/right wind swings during the lifetime of the sphere hanging there.

The McNally patent is a nice try to formulate a “catch all” forward looking patent, but it's obviously not giving the minimum practical solution.

It is somewhat resembling a vague and general patent of how to form a human base on Mars . . . Take a spaceship, load it with my list of items, fly, land it with its flight control system, and start living there using the items above . . . Good luck, and don't forget my royalties on the concept.

The following description on the other hand shows a detailed practical continuation towards a workable solution, which was achieved after years of experimentation, something McNally obviously didn't do. He just landed his manned helicopter after installing a warning sphere, and rushed to file a super wide drone installation patent, before somebody else does . . .

### SUMMARY OF THE INVENTION

Addressing the problems in the prior art, the McNally patent in paricular, and considering that a drone installation solution must be economically feasible and competing with the decades old manned helicopter installation, led to the following requirements of a possible solution:

The drone itself must be a standard commercial drone, factory assembled in great numbers, not a special design which will obviously be expensive and require a new and total certification, which for a relatively large drone weighing more than 10-15 kg, is a big deal.

The attaching of the sphere to the drone must be done in a simple straight forward way using the existing provisions of the drone, namely its retractable landing gears.

There is no available rotational power from the drone to the sphere, nor any electricity for turning electric screws or servo latches.

The attachment of the sphere to the cable must be absolute, meaning without any chances of gravitational longitudinal sliding or winds induced turning, and with no long-term abrasion damage to the cable. Furthermore, it must be easily adaptable to various cables, with different diameters.

There must be a simple visual means that will enable the remote operator of the drone to easily assess the exact height, angle and sideway misalignment of the sphere's inverted U opening against the cable in the final installation phase, and this means should be easily integrated into the drone's airborne video and wireless system, and properly displayed to the drone operator.

Since it's a very demanding job to do each and every such approach and installation for tens of spheres for each flying day, the chances of human error causing loss of drone and worse, must be minimized, and this requires an automated system, where this delicate last stage of the last 1 meter, “landing” precisely on the cable with right speed and pressure, and then breaking off vertically up leaving the sphere attached to the cable, must all be done with a hit of a switch.

### BRIEF DESCRIPTION OF THE DRAWINGS

The invention is illustrated in the following 3 figures.

FIG. 1 illustrates the Drone carrying the warning sphere.

FIG. 2 illustrates the Video system of the drone.

FIG. 3 illustrates the Remote control unit with the automatic sequencer option

Some blocks have “enlargements” drawings to better explain their looks and roles.

### DETAILED DESCRIPTION OF THE INVENTION

The following description of the drawings will explain how it works.

The description is intended mainly to augment the claims, in combination with the drawings. The drawings are merely illustrative block diagrams with an “artist view” visualization.

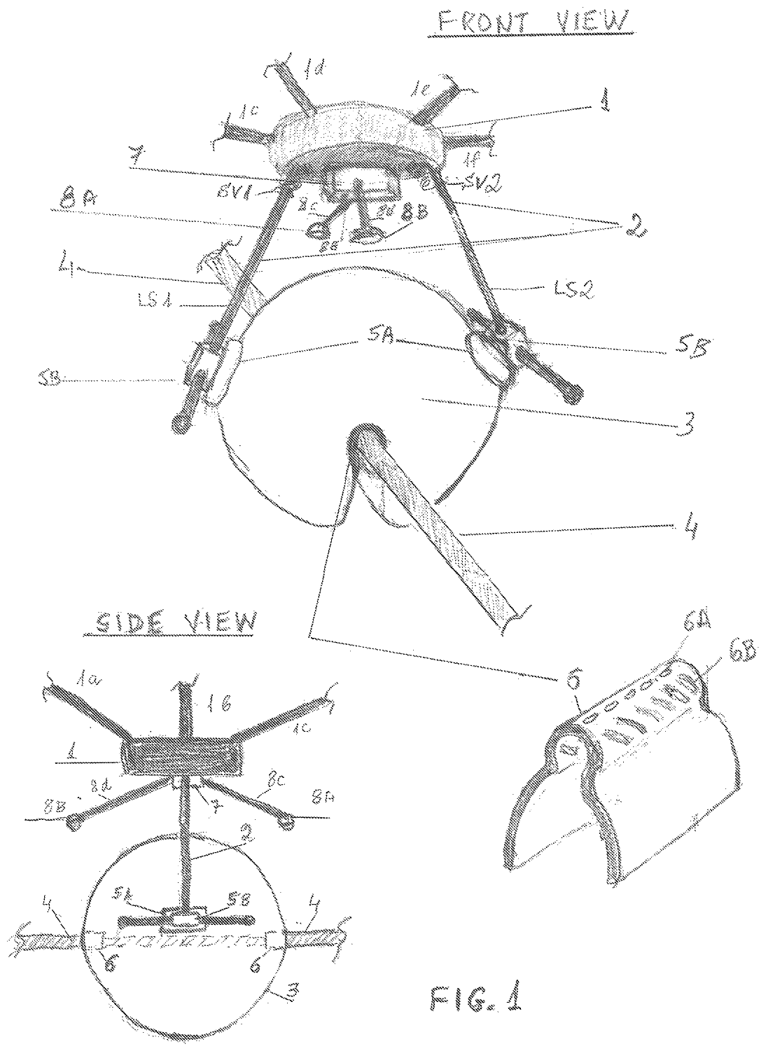

FIG. 1 illustrates how drone marked 1 with its two retractable landing gears marked 2 are holding and gripping warning sphere 3 using two protruding blocks 5B attached to the two landing skids LS1 and LS2. Two matching receptacles blocks 5A are secured onto the sphere or are an integral part of it during manufacturing. The height or diameter of sphere 3 where these are mounted matches the horizontal natural spacing between the two landing gears LS1 and LS2 in their extended down (drawn) position. This spacing is unique for each drone 1 model. Incorrect values and geometry can lead to failure in the retraction mechanism when lowering into cable 2 is completed and drone 1 tries to retract its landing gears LS1 and LS2 and climb up, because of drone's 1 electronics trying to protect the landing gears 2 retraction servos SV1 and SV2 due to current overload, as normally the LS1 and LS2 are not supporting such additional pulling down “payload” weight of around 5 kg.

FIG. 1 also shows two clamps marked 6. These flexible plastic clamps are uniquely matched to the diameter and stranding of the utility cable 1 through the slots 6B. Clamps 6 are screwed in place into the upper curved surface of the inverted U opening in the sphere 3 lower half. Elliptical holes 6A for the screws allow the clamp to slide several millimeters forward or backward into a perfect match with the spiraled strands shape of cable 4. This “perfect matching” is what ensures no slide and no turning of the installed sphere on the cable over the years, with rain, winds, and snow. Repetitive turning of clamp 6 around cable 4 can lead to wear in cable 4 and even catastrophic breaking of cable 4. Clamp 6 opening is slightly narrower than the cable 4 diameter, requiring pressure to squeeze cable 4 into clamp 6 diameter. Incorrect clamp opening will of course prevent successful installation, so it is critical that plastic clamp 6 is from the right material with the exact flexibility and rigidity and absolutely the right size for the particular cable 4 diameter and stranding in each and every sphere installed.

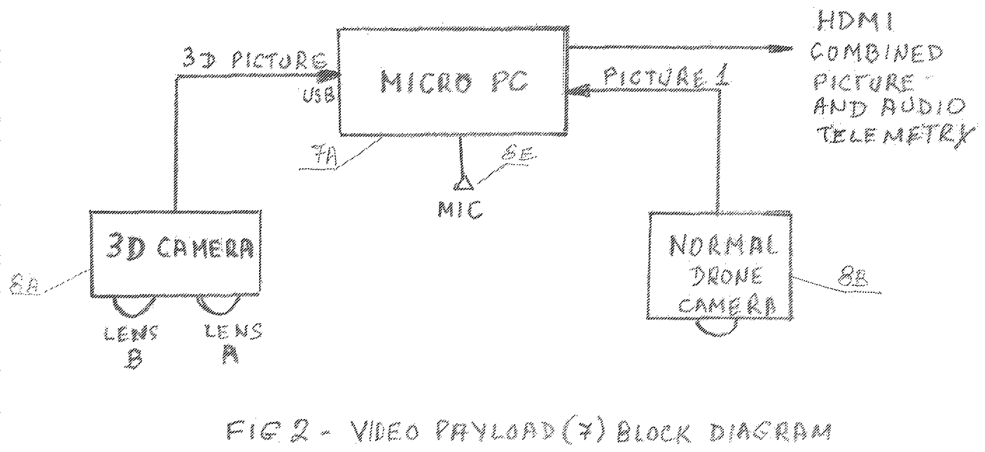

FIG. 2 shows the video payload 7 of drone 1 for this application. A stereoscopic 3D camera 8A is added to the drone's normal video camera 8B. 3D camera 8A has two lenses, lens A and lens B, with video sensor for each, which are spaced several centimeters from each other, filming the same scene but from slightly different angles, much like human vision with two eyes. 8A and 8B cameras are hung away from the center of drone 1 body, on two booms 8C and 8D respectively, one in front and one in back side of drone 1, with cameras pointing downwards to the area where cable 4 exits sphere 3. A micro-PC computer marked as 7a analyzes the two pictures, compares it line by line, pixel by pixel, and creates a 3D map with depth for each pixel in the scene from the information of horizontal shift between corresponding pixels of the two lenses of camera 8a. This is true and accurate for distance of centimeters to several meters. The depth is shown to the operator by assigning a different color or a greyscale value in b/w picture for each depth value, e.g., blue for near, until red for far. The drone's operator is trained to see this kind of color depth picture and to navigate the drone until the color (depth) of cable 4 looks just right, e.g., “deep blue” for 65 cm distance between camera and cable. This same camera and picture also help the drone's operator to immediately understand which cable from the “forest” of cables he sees below the drone towards ground is closest to the drone, and how far. The closest will naturally be the bluer of all cables.

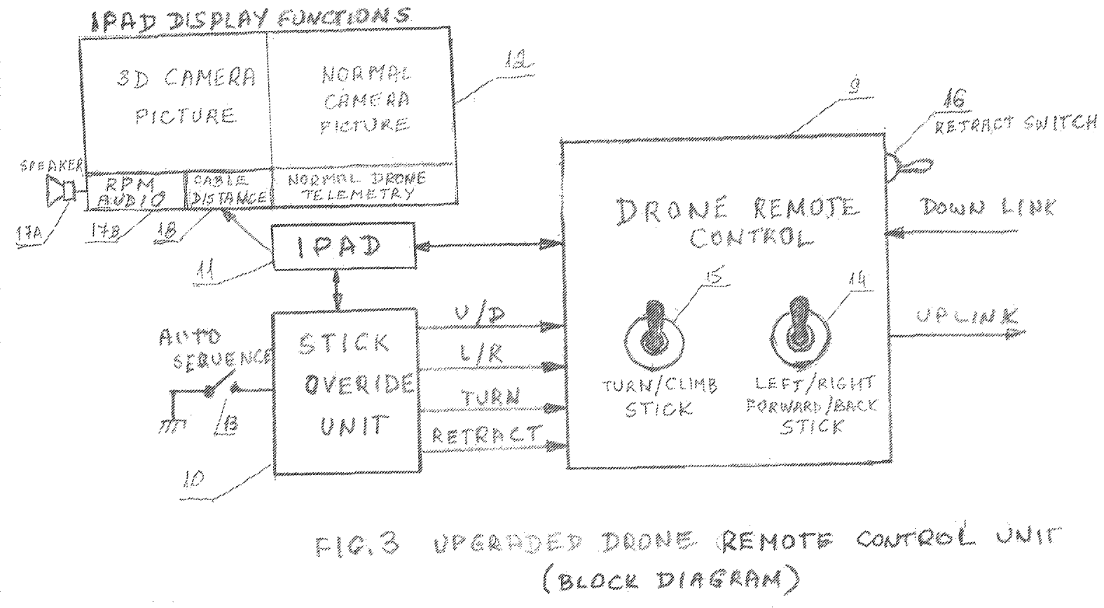

The airborne video payload 7 couples two pictures, from the 3D camera 8A and the normal camera 8B of the drone, into a unified picture signal into the HDMI or Analog video downlink of the drone. The two pictures side by side shown on Ipad display 12 of FIG. 3 are helping to show the operator the angle difference between sphere 3 center line and cable 4 and left/right misalignment of sphere 3 above cable 4. The angle difference is corrected to zero using the turn axis of the turn/climb stick 15 and left/right misalignment with the left/right axis of the left/right forward/back stick 14. When all looks aligned, the operator lowers drone 1 with sphere 3 slowly onto cable 4 by the climb axis of stick 15, until he feels “color distance” is right and doesn't change color anymore, meaning the drone 1 with sphere 3 are partially resting and leaning on cable 4. At this moment the RPM of the rotors will reduce automatically, because much less lift is required. The reduction of RPM will be picked up by microphone 8E marked as Mic and heard by the operator through RPM Speaker 17a to indicate correct “resting” on cable 4, meaning also seizure of clamps 6 onto cable 4. At this moment the operator will slowly try to gain back some lost height. If seizure to cable 4 was completed correctly, drone 1 will try to lift cable 4 through clamps 6 of seized sphere 3. If everything is right, RPM will increase quickly. The operator will then flip the retract switch 16 and retract the landing gears 2 upwards. This will cause separation of protruding blocks 5B from landing skids receptacle blocks 5A, with simultaneous liftoff of drone 1, jumping upwards.

FIG. 3 shows the upgraded remote control unit, and its video screens on the ground, with normal drone remote control 9. For upgraded performance over manual operation by the operator, there is an addition of a sticks override unit 10, with a momentary switch called auto sequencer and marked 13. Pushing auto sequencer 13 will start the above explained sequence of commands and corrections automatically, to make it easier, faster, more unified and accurate, in each and every sphere 3 installation, allowing operation by less “instinctive” and or alert pilots. In both manual and automatic modes the operator will monitor the process through the side by side pictures on monitor 12, and focus on the normal drone telemetry coming from drone 1, the cable distance from 3D camera 8A, and RPM audio 17b through speaker 17a.

What is claimed is:

1) A multi rotor remote controlled drone that holds and carries an aerial warning sphere with an inverted U groove in its underside, using its retractable landing gears. Said Drone lifts, flies, navigates said sphere, precisely aiming and lowering said U groove over a utility electric cable, and releasing this sphere by retracting said landing gears thereafter.

2) A drone with warning sphere of claim 1, further having protruding blocks attached to the landing skids of said retractable landing gears, and matching receptacles attached or being part of said sphere, enabling secure carrying and flying, and easy release of said sphere when retracting upwards or sideways said landing gears.

3) A drone with warning sphere of claim 1, further having horizontal or other shape grooves or holes in said sphere, to accommodate said landing gears and their landing skids or other elements attached to said landing gears, to carry and release said sphere.

4) A drone with warning sphere of claim 1 which further has a 3D stereoscopic or other depth measuring camera, connected to said Drone video downlink stream, with said camera pointing downwards or in diagonal to said utility cable area, giving the remote pilot the required video picture with graphic distance information that will immediately point to the closest cable from all cables in the scene, and also give the information of exact distance from said drone to that cable, to allow the initial hovering to the correct cable from all cables below, and a precise controlled descent into that particular cable.

5) An aerial warning sphere with an inverted V or U groove in its lower half, where a plastic or other flexible material clamp is attached to the top of said groove. Said clamp is further matched it its diameter and opening to the exact diameter of the utility electric cable to allow fitting upon pressure in the order of half of the drone self weight, and also has radial grooves in its circumference that circles the cable, matching the exact strands diameter and spiraling pitch of said strands. Such exact matching enables “perfect match” between clamp and cable, preventing gravitational longitudinal sliding, or wind induced rotation of said sphere on said cable.

6) The clamp and sphere of claim 5, with drone of claims 1 to 4

7) The drone of claim 4 where the remote control console of said drone also has analog or digital inputs from an automatic sequencer unit that processes that graphic distance information of claim 4, and said inputs override the control sticks of said remote console, to automatically make said precise controlled descent into said cable.

8) The Drone of claim 4 where a microphone is added to the airborne video system, to sense measure the average RPM of said drone in the downlink of said drone.

9) A video display of claim 4 where the RPM information of claim 8 is displayed graphically, numerically, with a discrete high/low RPM indication, or simply as an audio tone with a frequency proportional to said average RPM.

10) The drone and 3D camera of claim 4, where an additional airborne camera is combined to said 3D camera picture, and relayed to the remote operator video console, where both pictures will be displayed on a single screen, alongside the essential telemetry from the drone, like battery voltages, GPS etc.
